(19) United States
(12) Patent Application Publication
(10) Pub. No.: US 2022/0239033 A1
(43) Pub. Date: Jul. 28, 2022

(54) CONNECTOR

(71) Applicants: AUTONETWORKS TECHNOLOGIES, LTD., Mie (JP); SUMITOMO WIRING SYSTEMS, LTD., mie (JP); SUMITOMO ELECTRIC INDUSTRIES, LTD., Osaka (JP)

(72) Inventor: Seido NISHIJIMA, Mie (JP)

(21) Appl. No.: 17/606,593

(22) PCT Filed: Apr. 22, 2020
(86) PCT No.: PCT/JP2020/017279

§ 371 Date: Oct. 26, 2021

(30) Foreign Application Priority Data
May 13, 2019 (JP) 2019-090784

(51) Int. Cl. H01R 13/52; H01R 13/426

(52) U.S. Cl. CPC H01R 13/5208; H01R 13/426

(57) ABSTRACT

The present disclosure provides a connector improved in both assemblability and waterproofness. A connector is provided with a housing including a tubular wire inserting portion into which a wire member is partially inserted, a tubular rubber seal to be interposed between an inner surface of the wire inserting portion and an outer surface of the wire member, and a retainer for restricting escape of the rubber seal by being fixed to the wire inserting portion while being interposed between the inner surface of the wire inserting portion and the outer surface of the wire member. The rubber seal is formed with an annular recess recessed from one end surface and shaped to surround a through hole thereof. The retainer is provided with a fitting tube portion to be fit into the annular recess.

### TECHNICAL FIELD

The present disclosure relates to a connector.

### BACKGROUND

Conventionally, some connectors include a housing having a tubular wire inserting portion into which a wire member is partially inserted (see, for example, Patent Document 1). This connector includes a tubular rubber seal to be interposed between the inner surface of the wire inserting portion and the outer surface of the wire member and a retainer for restricting the escape of the rubber seal by being mounted in an opening of the wire inserting portion, and the intrusion of liquid into the connector along the wire member exposed to outside is prevented.

### PRIOR ART DOCUMENT

### Patent Document

Patent Document 1: JP 2018-055833 A

### SUMMARY OF THE INVENTION

### Problems to be Solved

In the connector as described above, an interval between the wire inserting portion and the wire member may become large. Specifically, such as when a thin wire member is also dealt with while a thick wire member is dealt with using the housings having the same product number as common components, the interval between the wire inserting portion and the wire member becomes large when the thin wire member is employed. In such a case, since the rubber seal provided in the entire clearance between the wire inserting portion and the wire member becomes thick, it has been difficult to improve the assemblability of the rubber seal with the wire inserting portion while improving waterproofness between the wire member and the rubber seal. That is, if it is attempted to use a rubber seal having a compression ratio equal to that of the rubber seal when the thick wire member is employed, an outer diameter of the rubber seal becomes excessively large and assemblability when the rubber seal is inserted into the wire inserting portion might be deteriorated.

The present invention was developed to solve the above problem and aims to provide a connector improved in both assemblability and waterproofness.

### Means to Solve the Problem

The present disclosure is directed to a connector with a housing including a tubular wire inserting portion, a wire member being partially inserted into the wire inserting portion, a tubular rubber seal to be interposed between an inner surface of the wire inserting portion and an outer surface of the wire member, and a retainer for restricting escape of the rubber seal by being fixed to the wire inserting portion while being interposed between the inner surface of the wire inserting portion and the outer surface of the wire member, wherein the rubber seal is formed with an annular recess recessed from one end surface and shaped to surround a through hole of the rubber seal, and the retainer is provided with a fitting tube portion to be fit into the annular recess.

### Effect of the Invention

According to the connector of the present disclosure, both assemblability and waterproofness can be improved.

### BRIEF DESCRIPTION OF THE DRAWINGS

FIG. 1 is a perspective view of a connector in one embodiment.

FIG. 2 is an exploded perspective view of the connector in the one embodiment.

FIG. 3 is a partial exploded perspective view of the connector in the one embodiment.

FIG. 4 is a partial section of the connector in the one embodiment.

FIG. 5 is a partial section of the connector in the one embodiment.

FIG. 6 is a partial section of the connector employing a thick wire member.

### Detailed Description to Execute the Invention

### [Description of Embodiments of Present Disclosure]

First, embodiments of the present disclosure are listed and described.

The connector of the present disclosure is provided with a housing including a tubular wire inserting portion, a wire member being partially inserted into the wire inserting portion, a tubular rubber seal to be interposed between an inner surface of the wire inserting portion and an outer surface of the wire member, and a retainer for restricting escape of the rubber seal by being fixed to the wire inserting portion while being interposed between the inner surface of the wire inserting portion and the outer surface of the wire member, wherein the rubber seal is formed with an annular recess recessed from one end surface and shaped to surround a through hole of the rubber seal, and the retainer is provided with a fitting tube portion to be fit into the annular recess.

According to this configuration, since the rubber seal is formed with the annular recess recessed from the one end surface and shaped to surround the through hole of the rubber seal and the retainer is provided with the fitting tube portion to be fit into the annular recess, waterproofness between the wire member and the rubber seal can be improved while the assemblability of the rubber seal with the wire inserting portion is improved even if an interval between the wire inserting portion and the wire member is large. That is, in the case of uniformly providing the rubber seal in the entire clearance when the interval between the wire inserting portion and the wire member is large, the rubber seal becomes thick and it is difficult to improve both the assemblability and the waterproofness. However, since a thickness of the rubber seal can be optimally set respectively inside and outside the fitting tube portion of the retainer, both the assemblability and the waterproofness can be improved. Further, the housing of this configuration can be used as a common component also when the wire member is thick. That is, if a thick wire member is employed, the interval between the wire inserting portion and the wire member becomes small and the rubber seal does not become thick even if the rubber seal is provided in the entire clearance. Thus, both the assemblability and the waterproofness can be improved.

Preferably, a contact length of the retainer with the wire inserting portion is set equal to or more than an inner diameter of the retainer.

According to this configuration, since the contact length of the retainer with the wire inserting portion is set equal to or more than the inner diameter of the retainer, i.e. equal to or more than a diameter of the wire member passed through the retainer, a force generated when the wire member is bent outside the wire inserting portion can be made less likely to be transmitted to the rubber seal by being mainly received by the retainer. Thus, the deformation of the rubber seal can be suppressed and waterproofness between the wire member and the rubber seal can be improved.

Preferably, a depth of the annular recess is set equal to or more than half the length of the rubber seal.

According to this configuration, since the depth of the annular recess is set equal to or more than half the length of the rubber seal, the thickness of the rubber seal can be set respectively inside and outside the fitting tube portion in a range equal to or more than half the length of the rubber seal. By so doing, the assemblability and the waterproofness can be further improved as compared to the case where the thickness of the rubber seal is set respectively inside and outside the fitting tube portion in a range less than half the length of the rubber seal.

### [Details of Embodiment of Present Disclosure]

A specific example of a connector of the present disclosure is described below with reference to the drawings. Note that the present invention is not limited to these illustrations and is intended to be represented by claims and include all changes in the scope of claims and in the meaning and scope of equivalents.

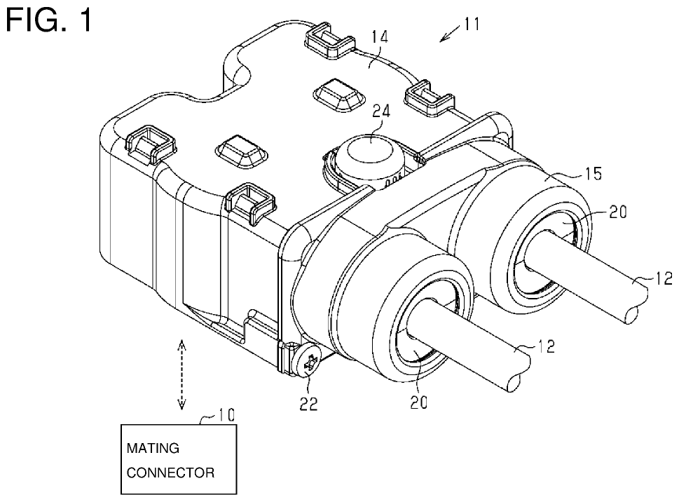

As shown in FIG. 1, a connector 11 is, for example, connected in a height direction to a mating connector 10 provided in an unillustrated electrical device such as an inverter installed in a vehicle. Further, the connector 11 is for electrically connecting wire members 12 held in the connector 11 to terminals of the mating connector 10 and holding these wire members 12.

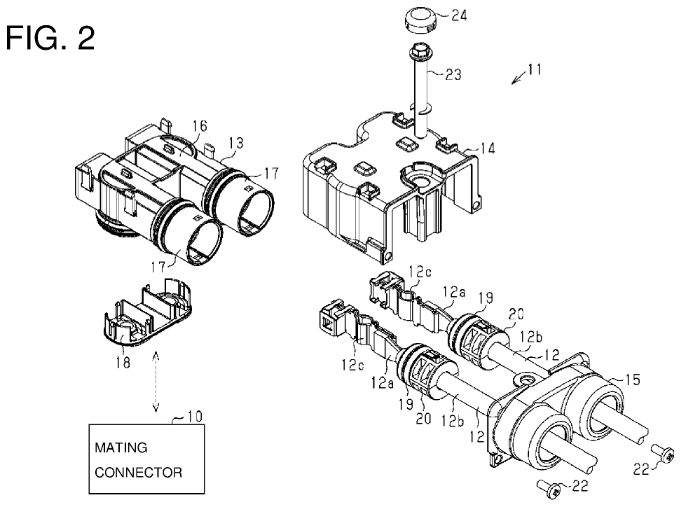

As shown in FIG. 2, the connector 11 includes a housing 13 and a first cover 14 and a second cover 15 provided to cover the outer surface of the housing 13. The housing 13 is made of a resin material. The first and second covers 14, 15 are made of a metal material and function as an electromagnetic shield.

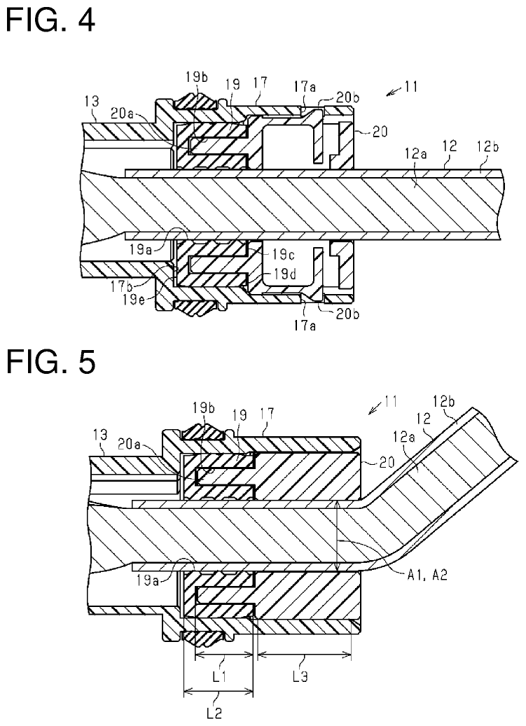

The housing 13 includes a body portion 16 and wire inserting portions 17 extending from the body portion 16 in a direction orthogonal to the height direction. The wire inserting portion 17 is formed into a tubular shape and open in the direction orthogonal to the height direction, and a tip part of the wire member 12 is inserted in the wire inserting portion 17. A pair of the wire inserting portions 17 of this embodiment have a hollow cylindrical shape and are provided side by side in parallel at the same height. A lower housing 18 to be connected to the mating connector 10 is fixed to a lower part in the height direction of the body portion 16 of the housing 13. The wire member 12 includes a core 12a such as a conductive metal wire, and an insulation coating 12b for covering the outer periphery of the core 12a (see FIGS. 4 and 5). A female terminal 12c to be electrically connected to the terminal of the mating connector 10 is fixed to a tip part of the core 12a exposed from the insulation coating 12b.

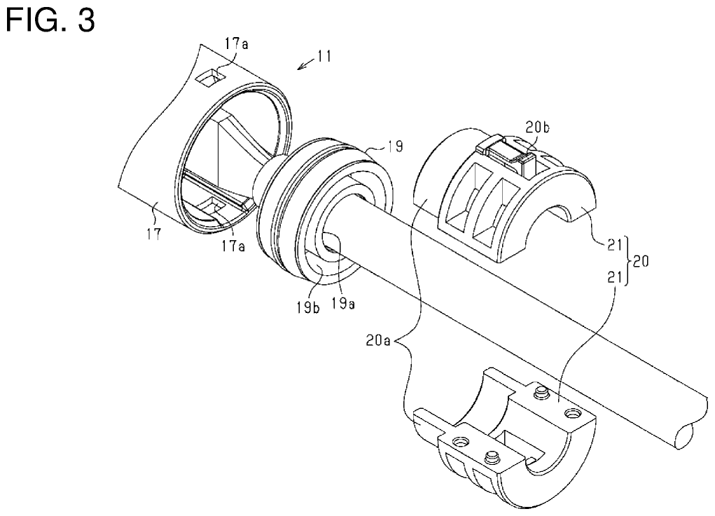

As shown in FIGS. 3 to 5, the connector 11 includes rubber seals 19 and retainers 20. The rubber seal 19 is formed into a tubular shape and interposed between the inner surface of the wire inserting portion 17 and the outer surface of the wire member 12. The retainer 20 is formed into a tubular shape and restricts the escape of the rubber seal 19 from the wire inserting portion 17 by being fixed to the wire inserting portion 17 while being interposed between the inner surface of the wire inserting portion 17 and the outer surface of the wire member 12.

The rubber seal 19 is formed with an annular recess 19b recessed from one end surface of the rubber seal 19 and shaped to surround a through hole 19a of the rubber seal 19. Further, the retainer 20 is provided with a fitting tube portion 20a to be fit into the annular recess 19b.

In particular, the rubber seal 19 is in the form of a tube having the through hole 19a in a center thereof, and the annular recess 19b surrounding the through hole 19a is formed in one end surface in a penetrating direction of the through hole 19a. As shown in FIG. 5, a depth L1 of the annular recess 19b is more than half the length L2 of the rubber seal 19 and, in this embodiment, set equal to or more than ¾ of the length L2 of the rubber seal 19.

As shown in FIG. 3, the retainer 20 is formed by combining a pair of retainer members 21 divided by 180° . As shown in FIG. 5, a contact length L3 of the retainer 20 with the wire inserting portion 17 is set equal to or more than an inner diameter A1 of the retainer 20, in other words, equal to or more than a diameter A2 of the wire member 12 passed through the retainer 20. Note that the wire members 12 employed in this embodiment have the diameter A2 of 18 mm. The retainer 20 is formed with the fitting tube portion 20a that is shaped to correspond to the annular recess 19b and be fit into the annular recess 19b substantially without any clearance, and fit into the annular recess 19b. The fitting tube portion 20a is divided and formed into the pair of retainer members 21. Further, as shown in FIGS. 3 and 4, the retainer 20 is formed with locking projections 20b resiliently deformable in a radial direction and projecting radially outward. The locking projection 20b is formed in each retainer member 21, and a pair of the locking projections 20b are provided at an interval of 180° in the retainer 20 formed by combining the pair of retainer members 21. When being inserted into the wire inserting portion 17, the retainer 20 is fixed to the wire inserting portion 17 by the locking projections 20b being fit and locked into locking holes 17a formed in the wire inserting portion 17. Note that FIG. 4 is a section of a part corresponding to the locking projections 20b, and FIG. 5 is a section of a part not provided with the locking projections 20b.

Next, an assembling procedure and functions of the connector 11 and the wire members 12 configured as described above are described.

As shown in FIG. 2, the rubber seals 19 and the retainers 20 are first assembled with the wire members 12 and tip sides of the wire members 12 are inserted into the wire inserting portions 17. At this time, as shown in FIG. 4, the rubber seal 19 is press-fit into the wire inserting portion 17, and the retainer 20 is fixed to the wire inserting portion 17 by the locking projections 20b being fit and locked into the locking holes 17a.

Then, the lower housing 18 is assembled with a lower part of the body portion 16 of the housing 13. Further, the first cover 14 is put on the body portion 16 of the housing 13 from above, the second cover 15 is put on the wire inserting portions 17 of the housing 13 and the second cover 15 is fixed to the first cover 14 by screws 22.

The connector 11 assembled as described above is connected to the mating connector 10 provided in the electrical device such as an inverter from above, and fixed to the electrical device by a screw 23 passed through the first cover 14 and threadably engaged with the electrical device. Note that a cap 24 is put on a head part of the screw 23. Further, although the connector 11 of this embodiment is configured to be connected to and assembled with the mating connector 10 from above, there is no limitation to this and an assembling method of the connector 11 may be changed to any one of all assembling methods such as a straight connection method and a bolt fastening method.

Next, functions of the above embodiment are described.

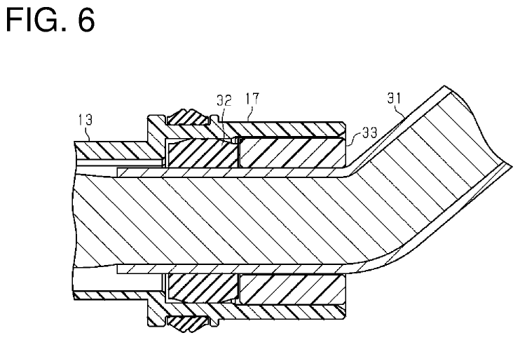

(1) The rubber seal 19 is formed with the annular recess 19b recessed from the one end surface and shaped to surround the through hole 19a of the rubber seal 19, and the retainer 20 is provided with the fitting tube portion 20a to be fit into the annular recess 19b. Thus, even if an interval between the wire inserting portion 17 and the wire member 12 is large, waterproofness between the wire member 12 and the rubber seal 19 can be improved while the assemblability of the rubber seal 19 with the wire inserting portion 17 is improved. That is, in the case of providing a rubber seal not including the annular recess 19b in the entire clearance when the interval between the wire inserting portion 17 and the wire member 12 is large, the rubber seal becomes thick and it is difficult to improve both the assemblability and the waterproofness. In contrast, since a thickness of the rubber seal 19 can be optimally set respectively inside and outside the fitting tube portion 20a of the retainer 20 in the configuration of this embodiment, both the assemblability and the waterproofness can be improved. Further, the housing 13 of this embodiment can be used as a common component also when the wire members 12 are thick. That is, as shown in FIG. 6, if a thick wire member 31 is employed, an interval between the wire inserting portion 17 and the wire member 31 becomes small. Even if a rubber seal 32 is provided in the entire clearance and a retainer 33 not including the fitting tube portion 20a is used, both the assemblability and the waterproofness can be improved since the rubber seal 32 does not become thick. In other words, both the assemblability and the waterproofness can be improved even if the thin wire members 12 are also dealt with while the thick wire members 31 are dealt with using the housings 13 having the same product number as common components.

(2) Since the contact length L3 of the retainer 20 with the wire inserting portion 17 is set equal to or more than the inner diameter A1 of the retainer 20, i.e. equal to or more than the diameter A2 of the wire member 12 passed through the retainer 20, a force generated when the wire member 12 is bent outside the wire 17 as shown in FIG. 5 can be made less likely to be transmitted to the rubber seal 19 by being mainly received by the retainer 20. Thus, the deformation of the rubber seal 19 can be suppressed and waterproofness between the wire member 12 and the rubber seal 19 can be improved.

(3) Since the depth L1 of the annular recess 19b is set equal to or more than half the length L2 of the rubber seal 19, the thickness of the rubber seal 19 can be set respectively inside and outside the fitting tube portion 20a in a range equal to or more than the length L2 of the rubber seal 19. By so doing, both the assemblability and the waterproofness can be improved as compared to the case where the thickness of the rubber seal 19 is set respectively inside and outside the fitting tube portion 20a in a range less than half the length of the rubber seal 19. Note that since the depth L1 of the annular recess 19b is set equal to or more than ¾ of the length L2 of the rubber seal 19, both the assemblability and the waterproofness can be further improved.

As shown in FIG. 4, the rubber seal 19 can include a resilient inner tube 19c defining the through hole 19a, a resilient outer tube 19d provided radially outwardly of the resilient inner tube 19c, and a bottom wall or annular wall 19e radially connecting the resilient inner tube 19c and the resilient outer tube 19d. An annular clearance defined between the resilient inner tube 19c and the resilient outer tube 19d of the rubber seal 19 constitutes the annular recess 19b. This annular recess 19b facilitates the resilient deformation of the rubber seal 19 and, thus, facilitates an operation of assembling the rubber seal 19 with the wire inserting portion 17. Further, a thickness of the resilient inner tube 19c, a thickness of the resilient outer tube 19d and a radial dimension of the annular wall 19e can be independently set. For example, radial dimensions of the resilient inner tube 19c, the resilient outer tube 19d and the annular wall 19e can be independently set according to an outer diameter of the wire member 12 and/or according to an inner diameter of the wire inserting portion 17 of the housing 13.

As shown in FIG. 4, the wire inserting portion 17 of the housing 13 can have a stopper surface or step 17b axially facing or in contact with the annular wall 19e of the rubber seal 19. This step 17b suppresses the entrance of liquid such as water in the rubber seal 19 into a back side of the housing 13 beyond the step 17b.

The resilient inner tube 19c and the resilient outer tube 19d of the rubber seal 19 may be in close contact with the fitting tube portion 20a of the retainer 20 over the entire circumference. Although not limited, the outer and inner peripheral surfaces of the fitting tube portion 20a of the retainer 20 may be smooth surfaces and the outer peripheral surface of the resilient inner tube 19c and the inner peripheral surface of the resilient outer tube 19d of the rubber seal 19 may be smooth surfaces. This configuration is advantageous in bringing the rubber seal 19 and the retainer 20 continuously into surface contact over an axial length. In a certain example, an operation of inserting the retainer 20 into the rubber seal 19 is facilitated. In another different example, an operation of separately mounting the rubber seal 19 and the retainer 20 into the wire inserting portion 17 is facilitated. For example, an operation of inserting the fitting tube portion 20a of the retainer 20 into the annular recess 19b of the rubber seal 19 after the rubber seal 19 is partially or entirely inserted into the wire inserting portion 17 is facilitated.

This embodiment can be modified and carried out as follows. This embodiment and the following modifications can be combined with each other and carried out without technically contradicting each other.

Although the contact length L3 of the retainer 20 with the wire inserting portion 17 is set equal to or more than the inner diameter A1 of the retainer 20, i.e. equal to or more than the diameter A2 of the wire member 12 passed through the retainer 20 in the above embodiment, there is no limitation to this and the length L3 may be set less than the inner diameter A1 of the retainer 20, i.e. less than the diameter A2 of the wire member 12.

Although the depth L2 of the annular recess 19b is set equal to or more than ¾ of the length L2 of the rubber seal 19 in the above embodiment, there is no limitation to this and the depth L1 may be set equal to or more than half the length L2 of the rubber seal 19 and less than ¾ of the length L2 of the rubber seal 19 or may be set less than half the length L2 of the rubber seal 19.

Although the wire inserting portion 17 has a hollow cylindrical shape in the above embodiment, there is no limitation to this and the wire inserting portion 17 may have another shape such as a rectangular tube shape. Note that, in this case, the outer shape of the rubber seal 19 preferably corresponds to the shape of the wire inserting portion.

Although the annular recess 19b and the fitting tube portion 20a have a circular shape in the above embodiment, there is no limitation to this and the annular recess 19b and the fitting tube portion 20a may have another annular shape such as a rectangular shape.

Although the retainer 20 is formed by combining the pair of retainer members 21 divided by 180° in the above embodiment, there is no limitation to this and, for example, the retainer 20 may be a single member or may be formed by combining three or more members.

Although the rubber seal 19 is formed into a single tubular member in the above embodiment, there is no limitation to this and, for example, the rubber seal 19 may be formed by combining two or more members.

Although the retainer 20 is fixed to the wire inserting portion 17 by the locking projections 20b being fit and locked into the locking holes 17a of the wire inserting portion 17 in the above embodiment, there is no limitation to this and the retainer 20 may be fixed to the wire inserting portion 17 by other than the locking projections 20b.

Although the connector 11 of the above embodiment includes a pair of the wire inserting portions 17, there is no limitation to this and the connector 11 may include, for example, only one wire inserting portion 17 or three or more wire inserting portions 17.

The wire inserting portion 17 of the housing 13 of the embodiment is an example of a tubular wire draw-out port. The rubber seal 19 of the embodiment is an example of a resilient seal plug. The retainer 20 of the embodiment is an example of a plug retainer configured to prevent the detachment of the resilient seal plug from the tubular wire draw-out port. The fitting tube portion 20a of the embodiment is an example of a tubular projection of the retainer 20.

The present disclosure includes the following implementation examples. Reference numerals of several constituent elements of illustrative embodiments are given not for limitation, but for understanding assistance. Matters described in the following implementation examples may be partly omitted or several of the matters described in the implementation examples may be selected or extracted and combined.

The wire inserting portion 17 of the housing 13 of the embodiment is an example of a tubular wire draw-out port. The rubber seal 19 of the embodiment is an example of a resilient seal plug. The retainer 20 of the embodiment is an example of a plug retainer configured to prevent the detachment of the resilient seal plug from the tubular wire draw-our port. The fitting tube portion 20a of the embodiment is an example of a tubular projection of the retainer 20.

The present disclosure includes the following implementation examples. Reference numerals of several constituent elements of illustrative embodiments are given not for limitation, but for understanding assistance. Matters described in the following implementation examples may be partly omitted or several of the matters described in the implementation examples may be selected or extracted and combined.

[Addendum 1]A connector (11) according to one or more implementation examples of the present disclosure includes:
a connector housing (13) having a tubular wire draw-out port (17);
a wire (12) to be drawn out to outside of the connector housing (13) from the tubular wire draw-out port (17),
a resilient seal plug (19) to be mounted into the tubular wire draw-out port (17) through an opening of the tubular wire draw-out port (17) and arranged between the inner surface of the tubular wire draw-out port (17) and the outer surface of the wire (12); and
a plug retainer (20) to be mounted into the tubular wire draw-out port (17) through the opening of the tubular wire draw-out port (17) and configured to prevent the detachment of the resilient seal plug (19) from the tubular wire draw-out port (17), wherein:
the resilient seal plug (19) includes a resilient inner tube (19c) configured to contact the outer surface of the wire (12) to stop water, a resilient outer tube (19d) configured to contact the inner surface of the tubular wire draw-out port (17) to stop water and an annular groove (19b) defined by the resilient inner tube (19c) and the resilient outer tube (19d), and

the plug retainer (20) includes a tubular projection (20a) to be inserted into the annular groove (19b) of the resilient seal plug (19).

[Addendum 2] In several implementation examples,

the tubular projection (20a) of the plug retainer (20) may be configured to radially press the resilient inner tube (19c) of the resilient seal plug (19) toward the outer surface of the wire (12), and

the tubular projection (20a) of the plug retainer (20) may be configured to radially press the resilient outer tube (19d) of the resilient seal plug (19) toward the inner surface of the tubular wire draw-out port (17).

[Addendum 3] In several implementation examples, the resilient seal plug (19) may be configured to be mountable into the tubular wire draw-out port (17) separately from the plug retainer (20) or with the resilient seal plug (19) mounted in the plug retainer (20).

[Addendum 4] In several implementation examples, the tubular projection (20a) of the plug retainer (20) may be configured to slide in contact with the annular groove (19b) of the resilient seal plug (19) in an axial direction before the resilient seal plug (19) is mounted into the tubular wire draw-out port (17) or after the resilient seal plug (19) is mounted into the tubular wire draw-out port (17).

[Addendum 5] In several implementation examples, the connector (11) may be provided on one end part of a vehicle wiring harness.

### LIST OF REFRENCE NUMERALS

11 connector
12 wire member
12a core
12b insulation coating
12c female terminal
13 housing
14 first cover
15 second cover
16 body portion
17 wire inserting portion
17a locking hole
18 lower housing
19 rubber seal
19a through hole
19b annular recess
20 retainer
20a locking projection
20b fitting tube portion
21 retainer member
22, 23 screw
24 cap
A1 inner diameter
A2 diameter
L1 depth
L2, L3 length

1. A connector, comprising:
a housing including a tubular wire inserting portion, a wire member being partially inserted into the wire inserting portion;
a tubular rubber seal to be interposed between an inner surface of the wire inserting portion and an outer surface of the wire member; and
a retainer for restricting escape of the rubber seal by being fixed to the wire inserting portion while being interposed between the inner surface of the wire inserting portion and the outer surface of the wire member, wherein:
the rubber seal is formed with an annular recess recessed from one end surface and shaped to surround a through hole of the rubber seal, the retainer is provided with a fitting tube portion to be fit into the annular recess, and the retainer is in contact with or facing the outer surface of the wire member at or near an opening of the wire inserting portion so that a force generated when the wire member is bent outside the wire inserting portion is less likely to be transmitted to the rubber seal, and a contact length of the retainer with the wire inserting portion is set equal to or more than an inner diameter of the retainer.

2. The connector according to claim 1, wherein a depth of the annular recess is set equal to or more than half the length of the rubber seal.

3 .(canceled)
